(19) United States
(12) Patent Application Publication
(10) Pub. No.: US 2014/0197689 A1
(43) Pub. Date: Jul. 17, 2014

(54) POWER SUPPLY PROVIDING LONGER LIFESPAN OF BATTERY MODULES

(71) Applicant: ZIPPY TECHNOLOGY CORP., New Taipei City (TW)

(72) Inventors: Tsun-Te SHIH, New Taipei City (TW); Yu-Yuan CHANG, New Taipei City (TW); Kuang-Lung SHIH, New Taipei City (TW); Po-Wen HSIAO, New Taipei City (TW)

(73) Assignee: ZIPPY TECHNOLOGY CORP., New Taipei City (TW)

(21) Appl. No.: 13/741,041

(22) Filed: Jan. 14, 2013

(51) Int. Cl. H02J 9/06

(52) U.S. Cl. CPC H02J 9/06
USPC 307/66

(57) ABSTRACT

A power supply capable of increasing the lifespan of battery modules controls the duty state of a main power supply system through a state switch control module. The state switch control module includes a power supply switch unit and a state switch unit. The power supply switch unit has a first power supply state in which the state switch unit outputs a first signal to allow the main power supply system to output a first power to charge a battery module, and a second power supply state in which the state switch unit outputs a second signal to allow the main power supply system to stop outputting the first power, and the battery module outputs the second power when the first electric potential of the first power is lower than the second electric potential of the second power.

### FIELD OF THE INVENTION

The present invention relates to a power supply that provides longer lifespan of battery modules and particularly to a power supply that shuts down a main power supply system and switches to a redundant power supply system to supply power at a preset time to avoid the battery modules in a power saturated state for a prolonged duration that might reduce the lifespan thereof.

### BACKGROUND OF THE INVENTION

Nowadays large scale processing systems for databases or servers or the like generally have a power supply with redundant power to provide stable power for operation for a prolonged period of time. A conventional power supply having redundant power, such as U.S. Pat. No. 7,495,415, mainly includes a main power supply module and a redundant power module. The main power supply module converts and outputs a conversion power in normal conditions. The redundant power module receives the conversion power in the normal conditions and saves the conversion power as redundant power. In the event that abnormal conditions occurred the main power supply module outputs the redundant power to stabilize the power supply.

Moreover, the general redundant power module usually saves electric power through a battery element. When the main power supply module is in the normal power supply conditions, the battery element is charged continuously and maintains in a power saturated state. Only when the main power supply module becomes abnormal, the battery element discharges. For the battery element that is maintained at the power saturated state for a prolonged duration, the active material filled inside changes and cannot provide desirable energy saving effect, and could result in decreasing of the lifespan. This makes the redundant power module unable to provide the redundant power as long as desired and impairs the uninterruptible power supply effect.

### SUMMARY OF THE INVENTION

The primary object of the present invention is to provide a power supply with a main power supply system shut down at a preset time interval and a redundant power supply system switched to allow a battery module therein to discharge for a short period of time to avoid the battery module from being maintained at a power saturated state for a prolonged duration.

To achieve the foregoing object, the present invention provides a power supply capable of increasing the lifespan of battery modules. The power supply includes a main power supply system, a redundant power supply system and a state switch control module. The main power supply system is electrically connected to an external power source to convert and output a first power. The redundant power supply system includes at least one battery module to receive and save the first power and output a second power parallel with the first power. The state switch control module includes a power supply switch unit to obtain a first electric potential of the first power and a second electric potential of the second power, and a state switch unit connected to the main power supply system to output a first signal and a second signal alternatively at a preset time interval to the main power supply system. The power supply switch unit has a first power supply state in which the state switch unit outputs the first signal to allow the main power supply system to output the first power to charge the battery module, and a second power supply state in which the state switch unit outputs the second signal to stop the main power supply system from outputting the first power to charge the battery module, and the battery module is switched to output the second power when the first electric potential is lower than the second electric potential.

In one embodiment the power supply switch unit includes an electric potential comparison unit to compare the first electric potential with the second electric potential to generate a comparison signal, and a power switch electrically connected to the electric potential comparison unit to get the comparison signal and control the power supply switch unit to enter the first power supply state or second power supply state.

In another embodiment the redundant power supply system includes a charge unit to receive the first power and charge the first power in the battery module.

In yet another embodiment the main power supply system further includes a rectification filter unit connected to the external power source, a power factor correction unit connected to the rectification filter unit, a transformer, a pulse width control unit, a switch element and a rectification output unit. In addition, the state switch unit is connected to the pulse width control unit or power factor correction unit to control operation of the main power supply system.

Through the structure set forth above, compared with the conventional techniques, the invention provides many advantages, notably:

The battery module has a longer lifespan. The state switch unit outputs the second signal at the preset time interval to make the main power supply system stop outputting the first power, namely the power supply switch unit is driven from the first power supply state to enter the second power supply state. At the second power supply state, the battery module discharges the second power; after another preset time interval elapses, the state switch unit stops outputting the second signal but starts outputting the first signal so that the power supply switch unit is switched from the second power supply state to the first power supply state again. Thereby the battery module can be charged and discharge at desirable time without being maintained at the power saturated state for a prolonged duration that might result in decrease of the lifespan thereof.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of a first embodiment of the power supply providing longer lifespan of battery modules of the invention.

FIG. 2 is a schematic waveform chart of a first signal and a second signal of the power supply of the invention.

FIG. 3 is a block diagram of a second embodiment of the power supply of the invention.

FIG. 4 is a block diagram of a third embodiment of the power supply of the invention.

### DETAILED DESCRIPTION OF THE PREFERRED EMBODIMENTS

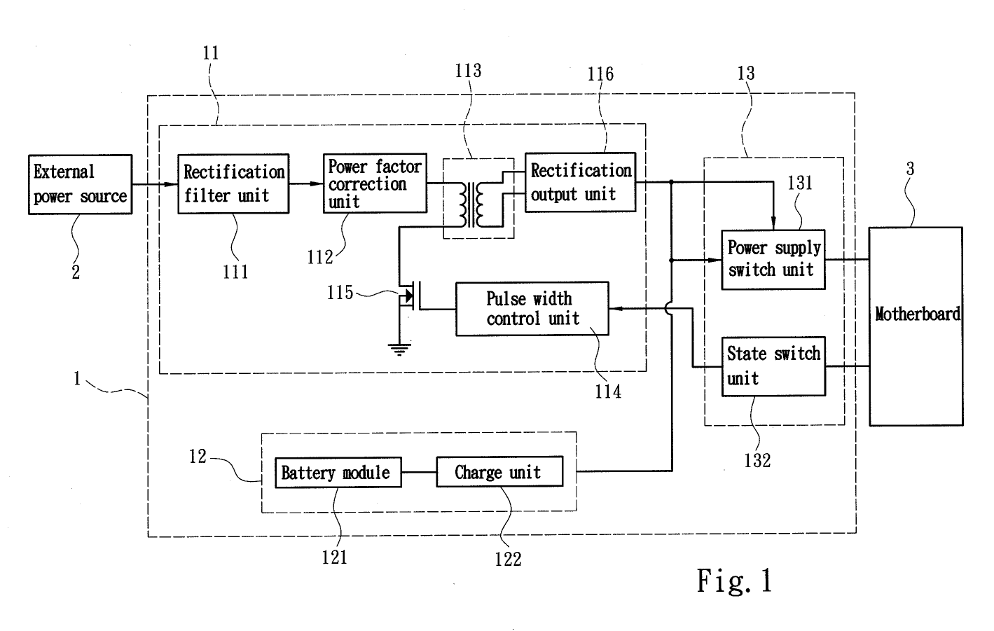

Please refer to FIG. 1, the invention aims to provide a power supply 1 that provides longer lifespan of battery modules. It mainly receives electric power from an external power source 2 and converts and supplies the power to a motherboard 3, a database or a server for operation. The power supply 1 comprises a main power supply system 11, a redundant power supply system 12 and a state switch control module 13. The main power supply system 11 includes a rectification filter unit 111 connected to the external power source 2, a power factor correction unit 112 connected to the rectification filter unit 111, a transformer 113, a pulse width control unit 114, a switch element 115 and a rectification output unit 116. The rectification filter unit 111 converts AC power output from the external power source 2 to DC power whose power factor in turn is regulated via a transformation electric potential in the power factor correction unit 112. The switch element 115 has a conduction cycle controlled by the pulse width control unit 114. The transformer 113 has a primary side and a secondary side to form magnetic coupling induction. Finally, the rectification output unit 116 outputs a first power with a first electric potential. The redundant power supply system 12 is coupled in parallel with the main power supply system 11 and includes at least one battery module 121 to receive and save the first power and output a second power parallel with the first power. The second power has a second electric potential different from the first electric potential and also lower than the first electric potential. Moreover, the redundant power supply system 12 can further include a charge unit 122 to receive the first power and charge the first power in the battery module 121 to become the second power.

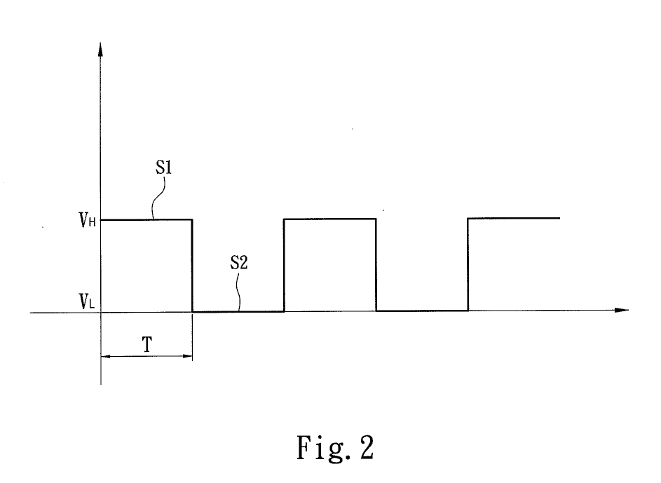

The state switch control module 13 includes a power supply switch unit 131 connected to the main power supply system 11 and redundant power supply system 12, and a state switch unit 132 connected to the main power supply system 11. The power supply switch unit 131 receives the first electric potential of the first power from the main power supply system 11 and the second electric potential of the second power from the redundant power supply system 12, and further compares the first electric potential with the second electric potential. When the first electric potential is higher than the second electric potential, the power supply switch unit 131 outputs the first power. If the first electric potential is lower than the second electric potential, the power supply switch unit 131 makes the battery module 121 output the second power. Also referring to FIG. 2, the state switch unit 132 has a first signal S1 and a second signal S2. When the first signal S1 is output, the main power supply system 11 outputs the first power. When the second signal S2 is output, the main power supply system 11 stops outputting the first power. The first and second signals S1 and S2 can be two signals with different electric potentials. For instance, if the first signal S1 is at a higher potential, the second signal S2 is at a lower potential. On the other hand, the first and second signals S1 and S2 can also be output at a present time interval T. Namely, the second signal S2 is output at the preset time interval after the first signal S1, and then the first signal S1 is output again at another preset time interval T to form a continuous and repetitive cycle. More specifically, the power supply switch unit 131 has a first power supply state in which the state switch unit 132 outputs the first signal S1 to allow the main power supply system 11 to output the first power to charge the battery module 121, and a second power supply state in which the state switch unit 132 outputs the second signal S2 to stop the main power supply system 11 from outputting the first power to charge the battery module 121, and the battery module 121 outputs the second power when the first electric potential is lower than the second electric potential.

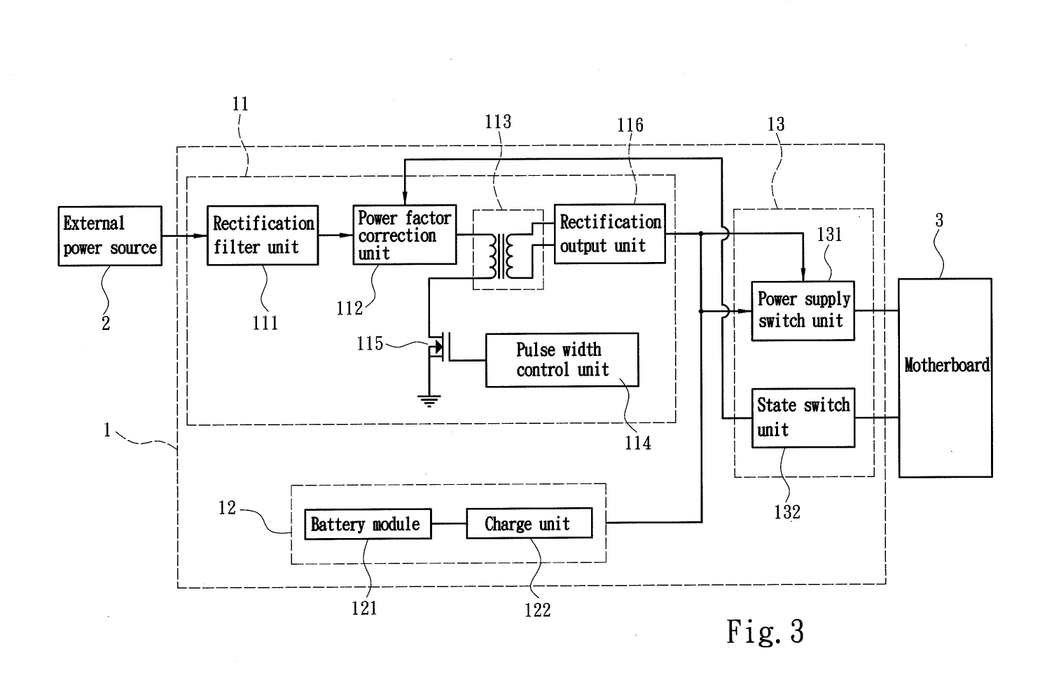

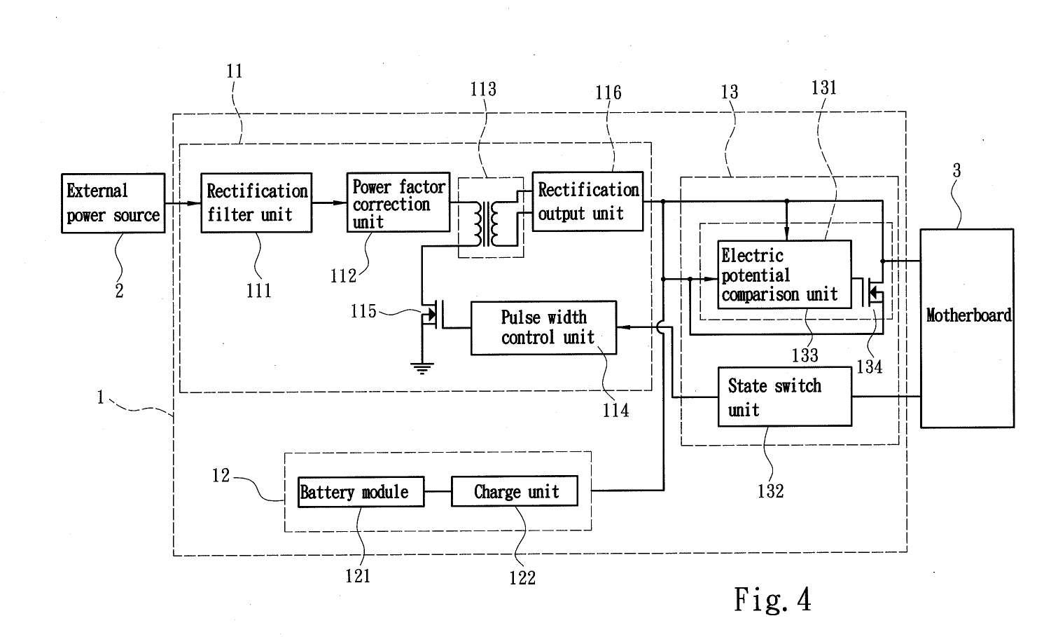

Please refer to FIG. 4, the power supply switch unit 131 has an electric potential comparison unit 133 and a power switch 134 connected to the electric potential comparison unit 133 and controlled thereby to enter the first power supply state or second power supply state. The electric potential comparison unit 133 compares the first electric potential with the second electric potential and generates a comparison signal. The power switch 134 receives the comparison signal to enter the first power supply state or second power supply state. Furthermore, the electric potential comparison unit 133 can be a comparator, and the power switch 134 can be an electronic element such as a transistor. Also referring to FIG. 1, switching the main power supply system 11 into the first power supply state or second power supply state can be accomplished in many ways. For instance, the state switch unit 132 can be connected to the pulse width control unit 114 with the operation condition of the pulse width control unit 114 controlled by the first signal or second signal. Or the state switch unit 132 can also be connected to the power factor correction unit 112 with the operation condition of the power factor correction unit 112 controlled by the first signal or second signal. Please refer to FIG. 3, the preset time interval T for state switching can be set according to specification characteristics of the battery module 121. Furthermore, the first signal S1 and second signal S2 of the state switch unit 132 can be received from the motherboard 3 or other external information equipments. More specifically, the state switch unit 132 can receive a turn-on signal (PS_on signal) output from the motherboard 3 and convert the turn-on signal to the first signal S1 or second signal S2 sent to the power supply 1.

Please refer to FIGS. 1 and 4, at the beginning of operation of the power supply 1, the state switch unit 132 outputs the first signal S1, the main power supply system 11 receives the power output from the external power source 2 and converts the power to the first power; meanwhile, the redundant power supply system 12 does not receive any power, and the first electric potential is higher than the second electric potential, such that the power supply switch unit 131 enters the first power supply state to allow the main power supply system 11 to output the first power to charge the battery module 121. After the preset time interval T elapses, the state switch unit 132 outputs the second signal S2 to shut down the main power supply system 11. The first electric potential gradually drops until lower than the second electric potential, and then the power supply switch unit 131 enters the second power supply state to allow the redundant power supply system 12 to output the second power to maintain power supply. After another preset time interval T elapses, the state switch unit 132 stops outputting the first signal S1 but starts outputting the second signal S2 to restart the main power supply system 11, and the first electric potential gradually increases until higher than the second electric potential to allow the power supply switch unit 131 to enter the first power supply state from the second power supply state. After another preset time interval T elapses, the state switch unit 132 outputs the second signal S2 again to repeat the charge and discharge processes previously discussed.

As a conclusion, the invention provides a power supply that can increase the lifespan of battery modules. It has a state switch control module to control the duty state of a main power supply system. The state switch control module has a power supply switch unit and a state switch unit. The power supply switch unit has a first power supply state in which the state switch unit outputs a first signal to make the main power supply system output a first power to charge a battery module, and a second power supply state in which the state switch unit outputs a second signal to make the main power supply system stop outputting the first power, and the battery module outputs the second power as the first electric potential of the first power is lower than the second electric potential of the second power. Thus the battery module of the redundant power supply system can be avoided from being maintained at the power saturated state constantly that might result in decreasing of the lifespan thereof.

While the preferred embodiments of the invention have been set forth for the purpose of disclosure, they are not the limitations of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power supply providing longer lifespan of battery modules, comprising:
a main power supply system which is electrically connected to an external power source and outputs a first power;
a redundant power supply system including at least one battery module to receive and save the first power and output a second power parallel with the first power; and
a state switch control module including a power supply switch unit to obtain a first electric potential of the first power and a second electric potential of the second power, and a state switch unit connected to the main power supply system to output a first signal and a second signal alternatively at a preset time interval to the main power supply system;
wherein the power supply switch unit includes a first power supply state in which the state switch unit outputs the first signal to the main power supply system to output the first power to charge the battery module, and a second power supply state in which the state switch unit outputs the second signal to the main power supply system to stop outputting the first power to charge the battery module, and the battery module outputs the second power when the first electric potential is lower than the second electric potential.

2. The power supply of claim 1, wherein the power supply switch unit includes an electric potential comparison unit to compare the first electric potential with the second electric potential to generate a comparison signal, and a power switch electrically connected to the electric potential comparison unit to get the comparison signal and control the power supply switch unit to enter the first power supply state or the second power supply state.

3. The power supply of claim 1, wherein the redundant power supply system includes a charge unit to receive the first power and charge the first power in the battery module.

4. The power supply of claim 1, wherein the main power supply system includes a rectification filter unit connected to the external power source, a power factor correction unit connected to the rectification filter unit, a transformer, a pulse width control unit, a switch element and a rectification output unit.

5. The power supply of claim 4, wherein the state switch unit is connected to the pulse width control unit to control operation of the main power supply system.

6. The power supply of claim 4, wherein the state switch unit is connected to the power factor correction unit to control operation of the main power supply system.
